(19) United States
(12) Patent Application Publication
(10) Pub. No.: US 2025/0190697 A1
(43) Pub. Date: Jun. 12, 2025

(54) HALLUCINATION SCORING METHOD AND APPARATUS IN HALLUCINATION SCORING SYSTEM

(71) Applicant: SELTA SQUARE CO., LTD., Seongnam-si (KR)

(72) Inventors: Min Kyung SHIN, Hwaseong-si (KR); Min Su LEE, Seoul (KR)

(21) Appl. No.: 18/976,338

(22) Filed: Dec. 11, 2024

(30) Foreign Application Priority Data
Dec. 11, 2023 (KR) 10-2023-0178817

(51) Int. Cl. G06F 40/20

(52) U.S. Cl. CPC G06F 40/20

(57) ABSTRACT

Disclosed herein are a method and apparatus for determining a hallucination score of an artificial intelligence model in a language processing system. The method for calculating a hallucination score includes receiving a prompt and an answer, inserting a keyword into the answer, generating a first word set by using words present in the prompt, generating a second word set by using words present in the answer with the inserted keyword, generating embedding vectors of the first word set and the second word set, and calculating a hallucination score based on the embedding vectors.

### CROSS REFERENCE TO RELATED APPLICATION

The present application claims priority to Korean Patent Application No. 10-2023-0178817 filed Dec. 11, 2023, the entire contents of which is incorporated herein for all purposes by this reference.

### BACKGROUND

### Field of the Disclosure

The present disclosure relates to a method and apparatus for determining a hallucination score of an artificial intelligence model in a language processing system.

### Description of the Related Art

Hallucination is one of the problems in using a large language model (LLM). An LLM generates a probability-based text that seems to be appropriate grammatically or semantically, but such a text is not always a right answer. The hallucination of an LLM may cause an ethical problem, and misinformation may be spread among users with little domain knowledge. Methods for solving the hallucination phenomenon mostly focus on the phase of training and building models by setting up reliable learning data or reinforcement learning. However, such methods have limitations in solving the hallucination phenomenon fundamentally and effectively. Accordingly, there is the need for fundamentally solving the hallucination phenomenon.

### SUMMARY

An object of the present disclosure is to provide a method and apparatus for determining a hallucination score of an artificial intelligence model in a language processing system.

An object of the present disclosure is to provide a method and apparatus for solving the hallucination phenomenon occurring in a large language model (LLM).

An object of the present disclosure is to provide a method and apparatus for calculating a hallucination score for a user's hallucination evaluation of an LLM answer.

The technical problems solved by the present disclosure are not limited to the above technical problems and other technical problems which are not described herein will become apparent to those skilled in the art from the following description.

According to an embodiment of the present disclosure, a method for determining a hallucination score of an artificial intelligence model in a language processing system may comprise receiving a prompt and an answer, inserting a keyword into the answer, generating a first word set by using words present in the prompt, generating a second word set by using words present in the answer with the inserted keyword, generating embedding vectors of the first word set and the second word set, and calculating a hallucination score based on the embedding vectors.

According to an embodiment of the present disclosure, an embedding vector of the second word set may be an embedding vector for one or more words combining a keyword and an answer.

According to an embodiment of the present disclosure, the first word set may be generated based on a number of words of the answer.

According to an embodiment of the present disclosure, the calculating of the hallucination score may comprise calculating a similarity score between an embedding vector of the first word set and the embedding vector of the second word set and calculating the hallucination score based on the similarity score.

According to an embodiment of the present disclosure, determining reliability of the answer based on comparison between the hallucination score and a threshold value may be further comprised.

According to an embodiment of the present disclosure, based on the hallucination score be equal to or greater than the threshold value, the reliability of the answer may be determined to be high, and based on the hallucination score be smaller than the threshold value, the reliability of the answer may be determined to be low.

According to an embodiment of the present disclosure, the similarity score may be calculated using one method among mean squared difference similarity, cosine similarity, Pearson similarity, or L2.

According to an embodiment of the present disclosure, the generating of the first word set may further comprise, based on the prompt including a plurality of sentences, dividing the prompt into sentence units, generating a first embedding vector of the plurality of the divided sentences, generating a second embedding vector of the second word set, calculating a similarity score based on the first embedding vector and the second embedding vector, selecting a sentence with the similarity score being highest, and generating word sets by using words present in the selected sentence and words present in the answer with the inserted keyword.

According to an embodiment of the present disclosure, the receiving of the prompt and the answer may comprise receiving a question and the prompt from a user, inputting the question and the prompt into an artificial intelligence (AI) system, obtaining an answer based on the prompt and the question that are input into the AI system, and receiving the obtained answer.

According to an embodiment of the present disclosure, the receiving of the prompt and the answer may comprise identifying a question input from a user, receiving a prompt from an external database based on the question, inputting the question and the prompt into an AI system, obtaining an answer based on the prompt and the question that are input into the AI system, and receiving the obtained answer.

According to an embodiment of the present disclosure, the embedding vector may be generated by using an AI model, and the AI model may include at least one of a sentence-transformer, a transformer, an LLM embedding model, or an OpenAI embedding model.

According to an embodiment of the present disclosure, an apparatus for determining a hallucination score of an artificial intelligence model in a language processing system may comprise a storage unit configured to store information necessary for operation of the apparatus and a processor connected to the storage unit. The processor may be configured to receive a prompt and an answer, to insert a keyword into the answer, to generate a first word set by using words present in the prompt, to generate a second word set by using words present in the answer with the inserted keyword, to generate embedding vectors of the first word set and the second word set, and to calculate a hallucination score based on the embedding vectors.

According to an embodiment of the present disclosure, the processor may be further configured to, based on the prompt including a plurality of sentences, divide the prompt into sentence units, to generate a first embedding vector of the plurality of the divided sentences, to generate a second embedding vector of the answer with the inserted keyword, to calculate a similarity score based on the first embedding vector and the second embedding vector, to select a sentence with the similarity score being highest, and to generate word sets by using words present in the selected sentence and words present in the answer with the inserted keyword.

According to an embodiment of the present disclosure, the processor may be further configured to receive a question and the prompt from a user, to input the question and the prompt into an artificial intelligence (AI) system, to obtain an answer based on the prompt and the question that are input into the AI system, and to receive the obtained answer.

According to an embodiment of the present disclosure, the processor may be further configured to receive a question from a user, to receive a prompt from an external database based on the question, to input the question and the prompt into an AI system, to obtain an answer based on the prompt and the question that are input into the AI system, and to receive the obtained answer.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 illustrates a structure of a system that provides a hallucination scoring method according to an embodiment of the present disclosure;

FIG. 2 illustrates a structure of an apparatus according to an embodiment of the present disclosure;

FIG. 3 illustrates a structure of an artificial neural network applicable to a system according to an embodiment of the present disclosure;

FIG. 4 illustrates a structure of a transformer according to an embodiment of the present disclosure;

FIG. 5 illustrates a flowchart of a hallucination scoring method according to an embodiment of the present disclosure;

FIGS. 6, 7, and 8 illustrate a structure of a hallucination scoring apparatus according to an embodiment of the present disclosure;

FIG. 9 illustrates a flowchart of a hallucination scoring method according to another embodiment of the present disclosure; and

FIGS. 10, 11, and 12 illustrate a structure of a hallucination scoring apparatus according to another embodiment of the present disclosure.

### DESCRIPTION OF THE PREFERRED EMBODIMENTS

Hereinafter, with reference to the accompanying drawings, embodiments of the present disclosure will be described in detail so that those skilled in the art can easily carry out the present disclosure. However, the present disclosure may be embodied in many different forms and is not limited to the embodiments described herein.

In describing the embodiments of the present disclosure, a detailed description of known functions and configurations will be omitted when it may obscure the subject matter of the present disclosure. In addition, in the drawings, portions which are not related to the description of the present disclosure will be omitted and similar portions are denoted by similar reference numerals.

The present disclosure proposes a technology for calculating a hallucination score of an artificial intelligence (AI) model in a language processing system (hallucination scoring system). To solve a hallucination phenomenon that is likely to occur in a large language model (LLM), the present disclosure may calculate a hallucination score using a post-processing method. Specifically, in a question-answer (QA) task that provides both a prompt and a question, a user may perform hallucination evaluation of an LLM answer through a language processing system. Through such hallucination scoring, the hallucination phenomenon, which has emerged as the biggest issue of LLMs, may be solved.

As a medical term, a hallucination means a false perception or belief that a stimulus exists or actually happens, although there is no external stimulus in fact. This medical meaning of “hallucination” is similarly used for the artificial intelligence (AI). A hallucination phenomenon in an AI means generating an unfaithful or non-sensical text irrelevant to data provided in a context of natural language processing (NLP). Such a hallucination phenomenon may cause an ethical problem, and misinformation may be spread among users with little domain knowledge. Accordingly, it is necessary to solve the hallucination phenomenon that occurs in the AI. Hereinafter, a language processing system for solving the hallucination phenomenon will be described in detail.

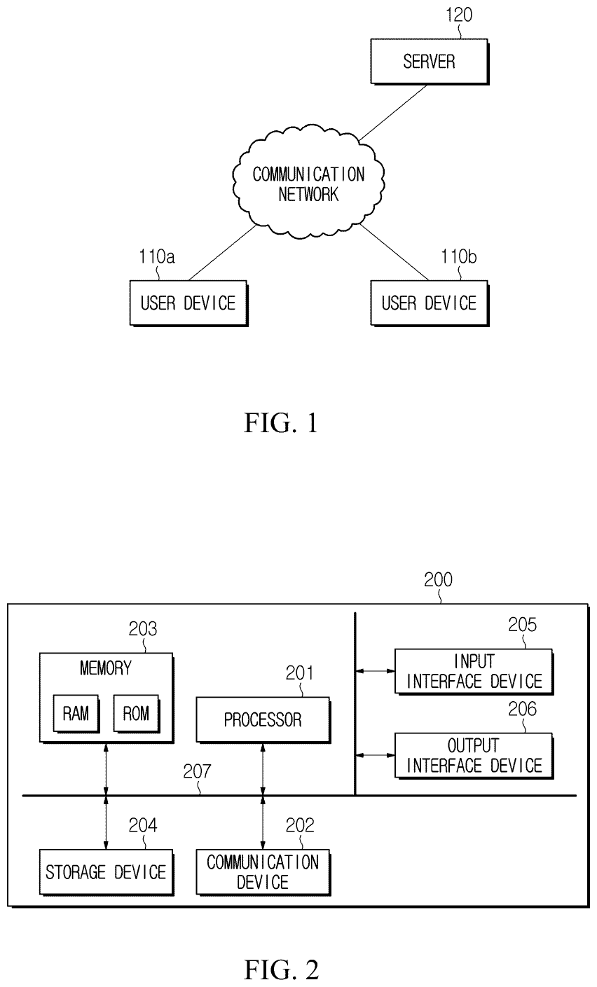

FIG. 1 illustrates a structure of a system that provides a safety information detection method according to an embodiment of the present disclosure.

Referring to FIG. 1, the system includes a user device 110a, a user device 110b, and a server 120 connected to a communication network. Although FIG. 1 illustrates two user devices 110a and 110b, three or more user devices may exist.

The user device 110a and the user device 110b are used by users who want to detect safety information in an electronic document using a platform according to an embodiment of the present disclosure. Here, the platform may refer to an operating system constituting a system that provides a safety information detection method according to the present disclosure. The user devices 110a and 110b may obtain input data (e.g., e-mail, user input, electronic documents, etc.), transmit the input data to the server 120 through the communication network, and interact with the server 120. Each of the user devices 110a and 110b may include a communication unit for communication, a storage unit for storing data and programs, a display unit for displaying information, an input unit for user input, and a processor for control. For example, each of the user devices 110a and 110b may be a general-purpose device (e.g., a smartphone, a tablet, a laptop computer, a desktop computer) or a platform-specific access terminal in which an application or program for platform access is installed.

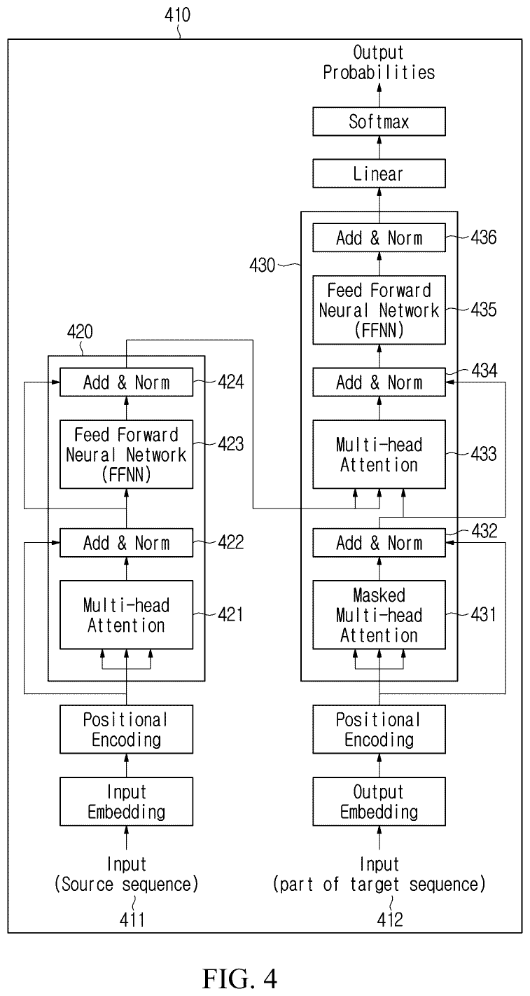

The server 120 provides a platform according to embodiments of the present disclosure. The server 120 provides various functions for a safety information detection platform in an electronic document and may operate an artificial intelligence model. An example of an artificial neural network applicable to the present disclosure will be described with reference to FIG. 4 below. In addition, the server 120 may perform learning for the artificial intelligence model using learning data. According to various embodiments of the present disclosure, the server 120 stores a plurality of artificial intelligence models for various analysis tasks included in the procedure for detecting safety information in the electronic document and selectively uses at least one of the artificial intelligence models if necessary. used selectively. Here, the server 120 may be a local server existing in a local network or a remote access server (e.g., a cloud server) connected through an external network. The server 120 may include a communication unit for communication, a storage unit for storing data and programs, and a processor for control.

FIG. 2 illustrates a structure of an apparatus according to an embodiment of the present disclosure. The apparatus 200 is a functional unit that uses a common storage space for data necessary for program execution. The apparatus 200 may include at least one computer and software associated therewith. The apparatus 200 may be understood as a structure of the server 120 of FIG. 1.

Referring to FIG. 2, the apparatus 200 includes at least one of a processor 201, a communication device 202, a memory 203, a storage device 204, an input interface device 205 or an output interface device 206, which communicate through a bus 207.

The processor 201 is hardware having a function of handling and/or processing various types of information within the apparatus 200. The processor 201 may be a semiconductor device that executes commands stored in a central processing unit (CPU), the memory 203 and/or the storage device 204.

The communication device 202 is a data transmission device for exchanging data with other devices or systems in data communication. The communication device 202 may include a data input/output device or a communication control device. For example, the communication device 202 enables communication of voice, video, and text data between the data system and other devices.

The memory 203 is a storage device capable of storing information. The information includes programs or software necessary for the operation of the apparatus 200, data generated during operation, and the like. The memory 203 may include a read only memory (ROM) and a random access memory (RAM). Here, the RAM may load data, process what is necessary, and store changes back. The ROM is a read-only storage device, and data stored in the ROM may be stored permanently or semi-permanently.

The storage device 204 may store various types of information processed in the apparatus 200. The storage device 204 may include various forms of volatile or non-volatile storage media.

The input interface device 205 may detect commands from the user and allow the user to operate the system. In addition, the output interface device 206 may display the result of the user's use of the system. The input interface device 205 and the output interface device 206 may be user interfaces (UIs).

The steps of a method or algorithm described in connection with the embodiments described herein may be directly embodied in a hardware or software module executed by the processor 201, or a combination of the two. A software module may be resided in a storage medium (i.e., the memory 203 and/or the storage device 204) such as a RAM memory, a flash memory, a ROM memory, an erasable programmable read only memory (EPROM), an electrically erasable programmable read only memory (EEPROM), a register, a hard disk, a detachable disc or a CD-ROM.

An exemplary storage medium is coupled to the processor 201, and the processor 201 may read information from the storage medium, and write information to the storage medium. Alternatively, the storage medium may be integral with the processor 201. The processor 201 and the storage medium may reside within an application specific integrated circuit (ASIC). The ASIC may reside in a user terminal. Alternatively, the processor and the storage medium may reside in a user terminal as separate components.

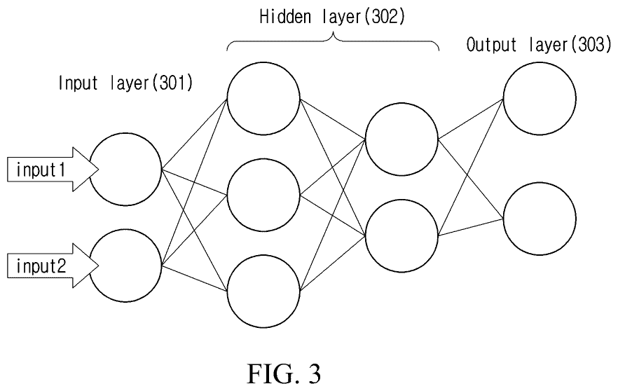

FIG. 3 illustrates a structure of an artificial neural network applicable to a system according to an embodiment of the present disclosure.

The artificial neural network shown in FIG. 3 may be understood as a structure of artificial intelligence (AI) models stored in the server 120 or a third apparatus capable of interworking with the server 120. In addition, the artificial neural network shown in FIG. 3 may be understood as a structure of artificial intelligence (AI) models used in the present disclosure, and may be understood as a structure of a feed forward neural network (FFNN) within the AI model.

Referring to FIG. 3, the artificial neural network includes an input layer 401, at least one hidden layer 402, and an output layer 403. Each of the layers 401, 402 and 403 is composed of a plurality of nodes, and each node is connected to output of at least one node belonging to a previous layer. Each node calculates an inner product of an output value of each of the nodes in the previous layer and a connection weight corresponding thereto, and then sends an output value multiplied with a non-linear activation function to at least one neuron in a next layer.

The artificial neural network shown in FIG. 3 may be formed by learning (e.g., machine learning, deep learning, etc.). In addition, artificial neural network models used in various embodiments of the present disclosure may include at least one of a fully convolutional neural network, a convolutional neural network, a recurrent neural network, a restricted Boltzmann machine (RBM) or a deep belief neural network (DBN), but is not limited thereto. Alternatively, machine learning methods other than deep learning may also be included. Alternatively, a hybrid model which is a combination of deep learning and machine learning may also be included. For example, by applying a deep learning-based model, features of an image are extracted, and a machine learning-based model may be applied when classifying or recognizing an image based on the extracted features. The machine learning-based model may include a Support Vector Machine (SVM), AdaBoost, and the like, but is not limited thereto.

A language processing system according to the present disclosure may be an LLM-based system. An LLM is a language model consisting of artificial neural networks with an enormous amount of parameters. Such an LLM may generate a probability-based text that seems to be appropriate grammatically and semantically. Such an LLM is used by major models like GPT (Generative pre-trained transformer), PaLM (Pathways Language Model) and LLaMA (Large Language Model Meta AI). Hereinafter, a structure of a transformer, which is fundamental to an LLM structure, will be described.

FIG. 4 illustrates a structure of a transformer according to an embodiment of the present disclosure. Referring to FIG. 4, a transformer 410 may consist of an encoder 420 and a decoder 430. The transformer 410 may perform learning to increase a probability value of a word corresponding to an answer when the encoder 420 and the decoder 430 are given inputs. Herein, the encoder 420 may compress and send information on a source sequence, which is an input 411 of the transformer, to the decoder 430. The decoder 430 may receive the compressed source sequence as input from the encoder 420 and generate a target sequence.

The encoder 420 may consist of components of multi-head attention 421, residual connection and layer normalization (Add&Norm) 422 and 424, and a feed forward neural network 423. The decoder 430 may consist of components of masked multi-head attention 431, residual connection and layer normalization (Add&Norm) 432, 434 and 436, multi-head attention 433, and a feed forward neural network 435. The decoder 430 may perform multi-head attention by using both the information sent by the encoder 420 and a part of the target sequence 412 input into the decoder 430 and be different from the encoder in this respect.

The multi-head attention 421 and 433, which are one of the components of the encoder 420 and the decoder 430 respectively, mean using self-attention in parallel. The self-attention may obtain how much correlation the words input to the encoder 420 or the decoder 430 have with each other. Specifically, the self-attention may extract vector values of respective words, and the correlation may be identified through matrix calculation of these vector values. By multiplying self-attention, accuracy may be enhanced, and the possibility of error occurrence may be lowered.

The masked multi-head attention 431 may have a same basic role as the multi-head attention 421 and 433. However, the masked multi-head attention 431 is a module present only in the decoder 430 and may have the part of the target sequence 412 as a calculation target. Unlike the encoder 420, the decoder 430 generates a sentence or derives an answer, and thus a word generated in front needs to be implemented not to see a word generated behind. Accordingly, the masked multi-head attention 431 may perform a task of masking a word generated in front so that the word cannot see a word generated behind. That is, the masked multi-head attention 431 may perform a masking task on a matrix so that an n-th generated word can see words from a first generated word to an n-th generated word but cannot see any words from an (n+1)-th generated word.

The feed forward neural networks 423 and 435 may train a model. The feed forward neural networks 423 and 435 may each consist of an input layer, at least one hidden layer, and an output layer and be a neural network in which an operation proceeds from the input layer to the output layer.

The feed forward neural networks 423 and 435 may minimize an error in an output value through repeated update of a weight during learning. The feed forward neural networks 423 and 435 may receive, as an input, a vector output from the multi-head attentions 421 and 433 and make a vector sequence of every word easy to be processed in a next transformer encoder.

The residual connection and layer normalization 422, 424, 432, 434 and 436 may play a role of connecting an input and an output between the multi-head attentions 421 and 433 and the feed forward neural networks 423 and 435. Specifically, residual connection may mean adding the input and output of a sub-layer. For example, residual connection may mean adding the input and output of the multi-head attentions 421 and 433. Alternatively, residual connection may mean adding the input and output of the feed forward neural networks 423 and 435.

Layer normalization refers to obtaining an average and variance for results obtained through residual connection and performing normalization using these results. The residual connection and layer normalization 422, 424, 432, 434 and 436 may prevent a layer-to-layer variation from increasing and help a model learn quickly.

Embodiments of the present disclosure may calculate a hallucination score by using a model with the transformer structure of FIG. 4. However, the present disclosure is not limited thereto, and a hallucination score may also be calculated by using various models. Hereinafter, embodiments of the present disclosure will be described.

### Embodiment 1

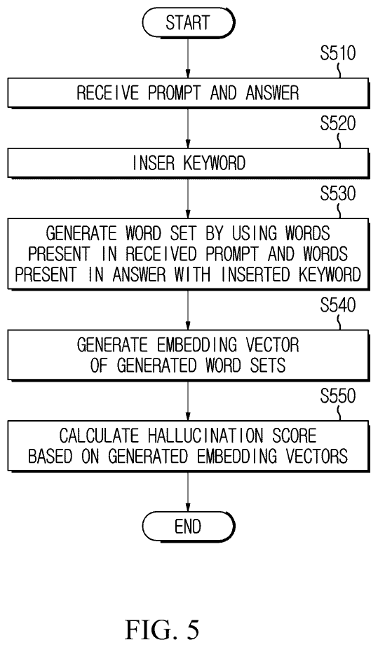

FIG. 5 illustrates a flowchart of a hallucination scoring method according to an embodiment of the present disclosure; Referring to FIG. 5, a language processing system may receive a prompt and an answer (S510). Herein, the prompt may be a sentence or file in various forms such as a single sentence, a plurality of sentences, and an electronic document (portable document format (PFD), web page, e-mail, scanned copy, image file, hangul word processor (hwp), txt, docx, and doc). In addition, the answer may refer to an answer that is obtained by inputting a prompt and a question into an LLM. That is, a user may enter a prompt and a question into an LLM and obtain an answer corresponding to the question, and the language processing system may receive the obtained answer and the prompt that is input into the LLM.

For example, when “A 40-year-old man with a 40-degree fever experienced abdominal pain after taking Tylenol.” and “How old is the patient?” are input as a prompt and a question respectively into the LLM and “40” is obtained as an answer, the language processing system may receive “A 40-year-old man with a 40-degree fever experienced abdominal pain after taking Tylenol.”, that is, the prompt input into the LLM and “40” that is the answer from the LLM.

The language processing system may insert a keyword (S520). That is, the language processing system may insert the keyword into the input answer. Herein, the keyword may be used to calculate semantic similarity to a word set to be generated at a later step. A keyword may be inserted by a user or be generated based on a prompt and/or a question input into the LLM and then be inserted. In the above example, the language processing system may add the keyword “age=” to the answer “40” and thus generate a final answer “age=40”. The present disclosure is not limited thereto, and the process of inserting a keyword may be omitted.

The language processing system may generate a word set by using words present in the received prompt and the answer with the inserted keyword (S530). Specifically, the language processing system may generate a word set (e.g., a first word set) by dividing the prompt received at step S510 into word units and removing a stop word. A stop word means a word that frequently appears in a sentence but is not quite useful in analyzing the sentence. A stop word may be defined by a user in advance and be defined by using a library such as the natural language toolkit (nltk). In the above example, the language processing system may remove the stop word and then generate the following word set (e.g., the first word set).
[“40-year-old”, “man”, “40-degree”, “fever”, “experience”, “abdominal”, “pain”, “taking”, “Tylenol”]

In addition, the language processing system may generate a word set (e.g., the first word set) with a same number of words as the answer received at step S510. Herein, the word set of the answer may be a word set of the answer with the inserted keyword. That is, the word set of the answer may be a word set for one word combining the keyword and the answer. Alternatively, the word set of the answer may be a word set for one sentence combining the keyword and the answer. That is, the word set of the answer may be a word set for one or more words, but the present disclosure is not limited thereto. For a detailed description using the above example, since the answer “40” has one word and thus a word set is already divided into a unit of one word, the language processing system may omit the process of generating a word set.

As another example, if “abdominal pain” is an answer generated in the above example, it has two words, and thus the language processing system may generate a new word set (e.g., a first word set) as follows by combining any two words present in the prompt.
[“40-year-old man”, “man 40-degree”, “40-degree fever”, “fever experienced”, “experienced abdominal”, “abdominal pain”, “pain taking”, “taking Tylenol”]

The language processing system may generate an embedding vector of generated word sets (S540). Specifically, the language processing system may generate an embedding vector by using AI models such as “sentence-transformer”, “transformer”, “LLM embedding model” and/or “OpenAI embedding model” for generated word sets and an answer with an inserted keyword. In the above example, the language processing system may generate embedding vectors like [[030232, . . . , −0.00593], [0.00952, . . . , 0.01373], . . . , [−0.000125, . . . , 0.00773]] by using [“40-year-old”, “man”, “40-degree”, “fever”, “experience”, “abdominal”, “pain”, “taking”, “Tylenol”] generated by the process of generating a word set. In addition, an embedding vector like [0.4941, 0.000090] may be generated by using “age=40”, that is, the answer with the inserted keyword.

The language processing system may calculate a hallucination score based on the generated embedding vectors (S550). Specifically, the language processing system may calculate similarity between embedding vectors of generated word sets and/or an embedding vector of an answer with an inserted keyword. After calculating similarity, the language processing system may return a highest similarity score. Calculation methods such as mean squared difference similarity, cosine similarity, Pearson similarity and L2 may be used to calculate similarity. In addition, a library like Facebook AI similarity search (faiss) or an engine like elasticsearch may be used to calculate similarity.

For a detailed description using the above example, the language processing system may calculate similarity between [[030232, . . . , −0.00593], [0.00952, . . . , 0.01373], . . . , [−0.000125, . . . , 0.00773]], which is th embedding vectors of [“40-year-old”, “man”, “40-degree”, “fever”, “experience”, “abdominal”, “pain”, “taking”, “Tylenol”], and [0.4941, . . . , 0.000090] that is the embedding vector of “age=40”. If similarity calculations are [0.8321, 0.3504, 0.6094, 0.1903, 0.1087, 0.0194, 0.1422, 0.1859, 0.2949], the highest similarity may be 0.8321 corresponding to “40-year-old”. That is, the highest score of 0.8321 may be a hallucination score, and the accuracy of an answer generated by the LLM may be determined using such a hallucination score. However, those skilled in the art will clearly understand that the order of the above steps can be changed.

According to the present disclosure, similarity may be derived in various ranges of values according to similarity calculation methods. For example, similarity may have a value between 0 and 1. In this case, when similarity becomes closer to 1, an answer may have higher accuracy. The present disclosure is not limited thereto, and when similarity becomes closer to 0, an answer may have higher accuracy.

As another example, similarity may be an integer. In this case, when similarity is smaller, an answer may have higher accuracy. The present disclosure is not limited thereto, and when similarity is greater, an answer may have higher accuracy.

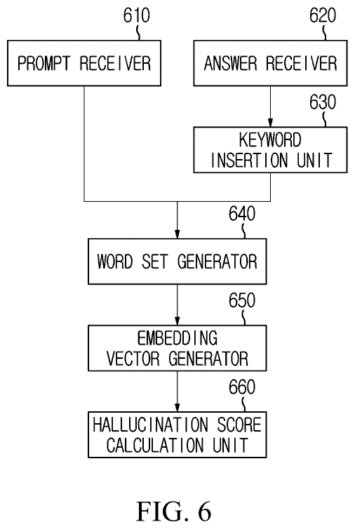

FIG. 6 illustrates a structure of a hallucination scoring apparatus according to an embodiment of the present disclosure. Referring to FIG. 6, the hallucination scoring apparatus may include a prompt receiver 610, an answer receiver 620, a keyword insertion unit 630, a word set generator 640, an embedding vector generator 650, and a hallucination score calculation unit 660.

The prompt receiver 610 may receive a prompt. Herein, the prompt may be a sentence or file in various forms such as a single sentence, a plurality of sentences, and an electronic document (portable document format (PFD), web page, e-mail, scanned copy, image file, hangul word processor (hwp), txt, docx, and doc).

The answer receiver 620 may receive an answer. Herein, the answer may refer to an answer that is obtained by inputting a prompt and a question into an LLM. That is, a user may enter a prompt and a question into an LLM and obtain an answer corresponding to the question, and the prompt receiver 610 and/or the answer receiver 620 may receive the obtained answer and the prompt that is input into the LLM.

The keyword insertion unit 630 may insert a keyword. Specifically, the keyword insertion unit 630 may insert a keyword into the answer received by the answer receiver 620. Herein, the keyword may be a word that may be used to calculate semantic similarity to a word set to be generated by the word set generator 640. The present disclosure is not limited thereto, and a keyword may be inserted by a user or be generated based on a prompt and/or a question input into the LLM and then be inserted. In addition, a keyword insertion process may be omitted.

The word set generator 640 may generate a word set by using words present in a prompt and an answer that are received by the prompt receiver 610 and the answer receiver 620 respectively. Specifically, the word set generator 640 may generate a word set (e.g., a first word set) by dividing the prompt into word units and removing a stop word. A stop word means a word that frequently appears in a sentence but is not quite useful in analyzing the sentence. A stop word may be defined by a user in advance and be defined by using a library such as the natural language toolkit (nltk).

In addition, the word set generator 640 may generate a word set (e.g., the first word set) with a same number of words as an answer. If an answer has one word, the word set generator 640 may not generate a word set because the one word is already a unit of word set division. As another example, if an answer has n words, the word set generator 640 may generate a new word set by combining words present in a prompt in n units. Herein, n may be a natural number.

The embedding vector generator 650 may generate embedding vectors of word sets (e.g., a first word set, a second word set) that are generated by the word set generator 640. Specifically, the embedding vector generator 650 may generate an embedding vector by using AI models such as “sentence-transformer”, “transformer”, “LLM embedding model” and/or “OpenAI embedding model” for generated word sets and an answer with an inserted keyword.

The hallucination score calculation unit 660 may calculate a hallucination score based on embedding vectors that are generated by the embedding vector generator 650. Specifically, the hallucination score calculation unit 660 may calculate similarity between embedding vectors of generated word sets and/or an embedding vector of an answer with an inserted keyword. After calculating similarity, the hallucination score calculation unit 660 may return a highest similarity score. The hallucination score calculation unit 660 may calculate similarity by using calculation methods such as mean squared difference similarity, cosine similarity, Pearson similarity and L2 may be used to calculate similarity. In addition, a library like Facebook AI similarity search (faiss) or an engine like elasticsearch may be used to calculate similarity.

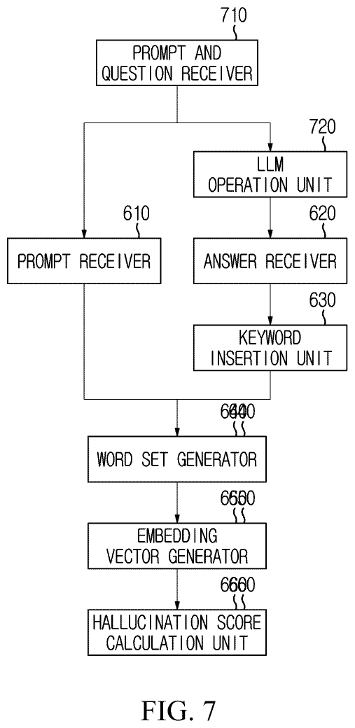

FIG. 7 illustrates a structure of a hallucination scoring apparatus according to an embodiment of the present disclosure. Referring to FIG. 7, the hallucination scoring apparatus may include a prompt and question receiver 710, an LLM operation unit 720, the prompt receiver 610, the answer receiver 620, the keyword insertion unit 630, the word set generator 640, the embedding vector generator 650, and the hallucination score calculation unit 660.

The prompt and question receiver 710 may receive a prompt and a question that are entered by a user. The prompt received by the prompt and question receiver 710 may then be transmitted to the prompt receiver 610. In addition, the prompt and question received by the prompt and question receiver 710 may be transmitted to the LLM operation unit 720.

The LLM operation unit 720 may derive an answer by using the prompt and question received from the prompt and question receiver 710. That is, an answer to the question entered by the user may be derived with reference to the prompt. The answer generated by the LLM operation unit 720 may be transmitted to the answer receiver 620. Herein, an LLM model according to the present disclosure may be ChatGPT, gpt, Llama and the like, but the present disclosure is not limited thereto.

The same functions described in FIG. 6 may be performed by the prompt receiver 610, the answer receiver 620, the keyword insertion unit 630, the word set generator 640, the embedding vector generator 650, and the hallucination score calculation unit 660, which are included in the hallucination scoring apparatus of FIG. 7.

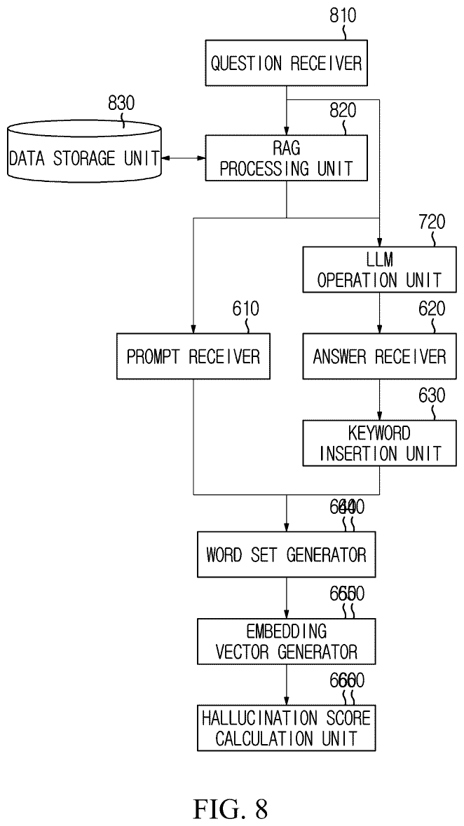

FIG. 8 illustrates a structure of a hallucination scoring apparatus according to an embodiment of the present disclosure. Referring to FIG. 8, the hallucination scoring apparatus may include a question receiver 810, a retrieval augmented generation (RAG) processing unit 820, a data storage unit 830, the LLM operation unit 720, the prompt receiver 610, the answer receiver 620, the keyword insertion unit 630, the word set generator 640, the embedding vector generator 650, and the hallucination score calculation unit 660.

The question receiver 810 may receive a question that is entered by a user. Herein, the question receiver 810 may not separately receive a prompt. The question received by the question receiver 810 may be transmitted to the RAG processing unit 820. The RAG processing unit 820 may retrieve a prompt from an external data source and generate a text based on information on the prompt. Accordingly, the RAG processing unit 820 may retrieve a most appropriate prompt for an entered question from the data storage unit 830 and receive a retrieval result. Herein, the data storage unit may be an internal or external database but is not limited thereto and may mean any data storage storing relevant information.

A prompt received by the RAG processing unit 820 may be transmitted to the prompt receiver 610. In addition, a prompt received by the RAG processing unit 820 and a question received by the answer receiver 810 may be transmitted to the LLM operation unit 720. When receiving the prompt and the question, the LLM operation unit 720 may derive an answer by using the received prompt and question. That is, the LLM operation unit 720 may derive the answer to the question entered by the user. The answer generated by the LLM operation unit 720 may be transmitted to the answer receiver 620. Herein, an LLM model according to the present disclosure may be ChatGPT, gpt, Llama and the like, but the present disclosure is not limited thereto.

The same functions described in FIG. 6 may be performed by the prompt receiver 610, the answer receiver 620, the keyword insertion unit 630, the word set generator 640, the embedding vector generator 650, and the hallucination score calculation unit 660, which are included in the hallucination scoring apparatus of FIG. 8.

### Embodiment 2

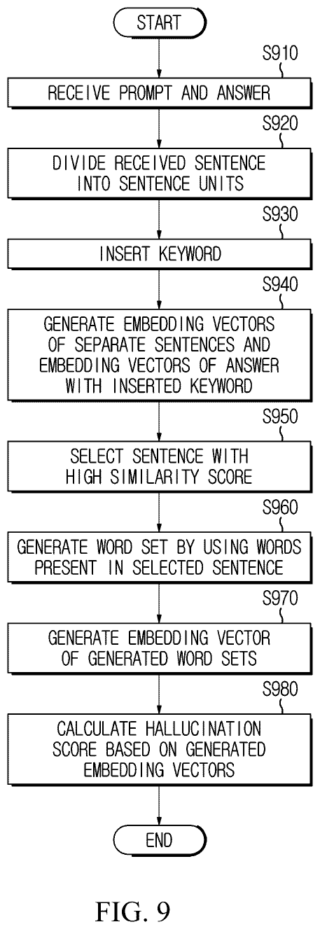

FIG. 9 illustrates a flowchart of a hallucination scoring method according to an embodiment of the present disclosure; Referring to FIG. 9, a language processing system may receive a prompt and an answer (S910). Herein, the prompt may be a sentence or file in various forms such as a single sentence, a plurality of sentences, and an electronic document (portable document format (PFD), web page, e-mail, scanned copy, image file, hangul word processor (hwp), txt, docx, and doc). In addition, the answer may refer to an answer that is obtained by inputting a prompt and a question into an LLM. That is, a user may enter a prompt and a question into an LLM and obtain an answer corresponding to the question, and the obtained answer and the prompt, which is entered into the LLM, may be transmitted to the language processing system.

For example, when a prompt “A 40-year-old man with a 40-degree fever experienced abdominal pain after taking Tylenol. He took ibuprofen, and his abdominal pain disappeared” and a question “How old is the patient?” are input into the LLM and “40” is obtained as an answer, the language processing system may receive “A 40-year-old man with a 40-degree fever experienced abdominal pain after taking Tylenol. He took ibuprofen, and his abdominal pain disappeared.”, that is, the prompt input into the LLM and “40” that is the answer from the LLM.

The language processing system may divide a received prompt into sentence units (S920). For a description using the above example, the language processing system may divide the received prompt “A 40-year-old man with a 40-degree fever experienced abdominal pain after taking Tylenol. He took ibuprofen, and his abdominal pain disappeared.” into sentence units as follows.
[“A 40-year-old man with a 40-degree fever experienced abdominal pain after taking Tylenol.”, “He took ibuprofen, and his abdominal pain disappeared.”]

The language processing system may insert a keyword (S930). That is, the language processing system may insert the keyword into the input answer. Herein, the keyword may be used to calculate semantic similarity to a word set to be generated at a later step. A keyword may be inserted by a user or be generated based on a prompt and/or a question input into the LLM and then be inserted. In the above example, the language processing system may add the keyword “age=” to the answer “40” and thus generate a final answer “age=40”. The present disclosure is not limited thereto, and the process of inserting a keyword may be omitted.

The language processing system may generate embedding vectors of the separate sentences and embedding vectors of the answer with the inserted keyword (S940). Specifically, the language processing system may generate embedding vectors of all the separate sentences and the answer with the inserted keyword by using AI models such as “sentence-transformer”, “transformer”, “LLM embedding model” and/or “OpenAI embedding model” for generated word sets and an answer with an inserted keyword. Herein, an embedding vector generated based on the separate sentences may be a first embedding vector, and an embedding vector generated based on the answer with the inserted keyword may be a second embedding vector. For a description using the above example, the language processing system may generate embedding vectors (first embedding vector) like [[0.3594, . . . 0.00112], [0.00531, . . . 0.04171]] by using the separate sentences [“A 40-year-old man with a 40-degree fever experienced abdominal pain after taking Tylenol.”, “He took ibuprofen, and his abdominal pain disappeared.”]. In addition, the language processing system may generate an embedding vector (second embedding vector) like [0.4941, . . . , 0.000090] by using “age=40”, that is, the answer with the inserted keyword.

The language processing system may select a sentence with a high similarity score (S950). Specifically, the language processing system may select a sentence corresponding to a highest similarity score by calculating similarity between the embedding vector (first embedding vector) of the sentences generated at step S940 and the embedding vector (second embedding vector) of the answer with the inserted keyword. That is, the language processing system may select only one sentence with high similarity from a plurality of sentences. However, the present disclosure is not limited thereto, and top n sentences with high similarity may be selected. Herein, n may be a natural number.

Calculation methods such as mean squared difference similarity, cosine similarity, Pearson similarity and L2 may be used to calculate similarity. In addition, a library like Facebook AI similarity search (faiss) or an engine like elasticsearch may be used to calculate similarity.

For a detailed description using the above example, the language processing system may calculate similarity between the embedding vectors [[0.3594, . . . 0.00112], [0.00531, . . . 0.04171]] of [“A 40-year-old man with a 40-degree fever experienced abdominal pain after taking Tylenol.”, “He took ibuprofen, and his abdominal pain disappeared.”] and the embedding vector [0.4941, . . . , 0.000090] of “age=40”. If a similarity calculation result is [0.6352, 0.1742], a sentence with highest similarity may correspond to “A 40-year-old man with a 40-degree fever experienced abdominal pain after taking Tylenol.” with the similarity score of “0.6352”.

The language processing system may generate a word set by using words present in the sentence selected at step S940 (S960). Specifically, the language processing system may generate a word set (first word set) by dividing the selected sentence of step S940 into word units and removing a stop word. A stop word means a word that frequently appears in a sentence but is not quite useful in analyzing the sentence. A stop word may be defined by a user in advance and be defined by using a library such as the natural language toolkit (nltk). For a description using the above example, the language processing system may remove a stop word from the selected sentence and then generate the following word set.
[“40-year-old”, “man”, “40-degree”, “fever”, “experience”, “abdominal”, “pain”, “taking”, “Tylenol”]

In addition, the language processing system may generate a word set (first word set) with a same number of words as the answer received at step S910. For a detailed description using the above example, since the answer “40” has one word and thus a word set is already divided into a unit of one word, the language processing system may not perform the process of generating a word set.

As another example, if “abdominal pain” is an answer generated in the above example, it has two words, and thus the language processing system may generate a new word set as follows by combining any two words present in the prompt.
[“40-year-old man”, “man 40-degree”, “40-degree fever”, “fever experienced”, “experienced abdominal”, “abdominal pain”, “pain taking”, “taking Tylenol”]

The language processing system may generate an embedding vector of generated word sets (S970). Specifically, the language processing system may generate an embedding vector by using AI models such as “sentence-transformer”, “transformer”, “LLM embedding model” and/or “OpenAI embedding model” for generated word sets and an answer with an inserted keyword. In the above example, the language processing system may generate embedding vectors like [[030232, . . . , −0.00593], [0.00952, . . . , 0.01373], . . . , [−0.000125, . . . , 0.00773]] by using [“40-year-old”, “man”, “40-degree”, “fever”, “experience”, “abdominal”, “pain”, “taking”, “Tylenol”] generated by the process of generating a word set. In addition, an embedding vector like [0.4941, . . . , 0.000090] may be generated by using “age=40”, that is, the answer with the inserted keyword. However, when the embedding vector of the answer with the inserted keyword is generated at step S940, the process of generating an embedding vector of an answer with an inserted keyword at step S970 may be omitted. In this case, the language processing system may generate only an embedding vector of a generated word set.

The language processing system may calculate a hallucination score based on the generated embedding vectors (S980). Specifically, the language processing system may calculate similarity between embedding vectors of generated word sets and/or an embedding vector of an answer with an inserted keyword. After calculating similarity, the language processing system may return a highest similarity score. Calculation methods such as mean squared difference similarity, cosine similarity, Pearson similarity and L2 may be used to calculate similarity. In addition, a library like Facebook AI similarity search (faiss) or an engine like elasticsearch may be used to calculate similarity.

For a detailed description using the above example, the language processing system may calculate similarity between [[030232, . . . , −0.00593], [0.00952, . . . , 0.01373], . . . , [−0.000125, . . . , 0.00773]], which is th embedding vectors of [“40-year-old”, “man”, “40-degree”, “fever”, “experience”, “abdominal”, “pain”, “taking”, “Tylenol”], and [0.4941, . . . , 0.000090] that is the embedding vector of “age=40”. If similarity calculations are [0.8321, 0.3504, 0.6094, 0.1903, 0.1087, 0.0194, 0.1422, 0.1859, 0.2949], the highest similarity may be 0.8321 corresponding to “40-year-old”. That is, the highest score of 0.8321 may be a hallucination score, and the accuracy of an answer generated by the LLM may be determined using such a hallucination score. However, those skilled in the art will clearly understand that the order of the above steps can be changed.

Thus, by adding a processing of dividing a received sentence into sentence units and selecting a sentence with high similarity, the language processing system may perform a procedure more quickly even when scoring hallucinations by using a long prompt consisting of a plurality of sentences.

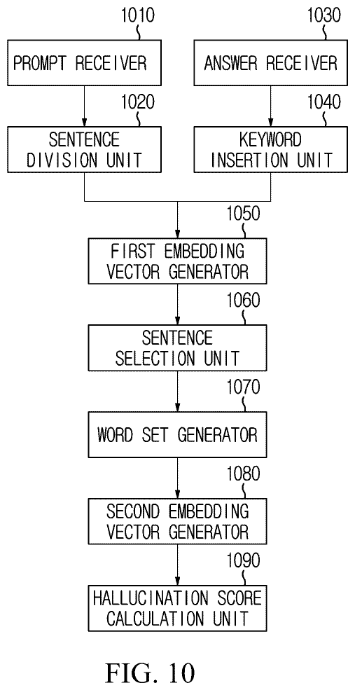

FIG. 10 illustrates a structure of a hallucination scoring apparatus according to an embodiment of the present disclosure. Referring to FIG. 10, the hallucination scoring apparatus may include a prompt receiver 1010, a sentence division unit 1020, an answer receiver 1030, a keyword insertion unit 1040, a first embedding vector generator 1050, a sentence selection unit 1060, a word set generator 1070, a second embedding vector generator 1080, and a hallucination score calculation unit 1090.

The prompt receiver 1010 may receive a prompt. Herein, the prompt may be a sentence or file in various forms such as a single sentence, a plurality of sentences, and an electronic document (portable document format (PFD), web page, e-mail, scanned copy, image file, hangul word processor (hwp), txt, docx, and doc). The sentence division unit 1020 may divide a prompt received by the prompt receiver 1010 into sentence units. This may be directed to calculating a similarity score in a sentence unit.

The answer receiver 1030 may receive an answer. Herein, the answer may refer to an answer that is obtained by inputting a prompt and a question into an LLM. That is, a user may enter a prompt and a question into an LLM and obtain an answer corresponding to the question, and the language processing system may receive the obtained answer and the prompt that is input into the LLM.

The keyword insertion unit 1040 may insert a keyword. Specifically, the keyword insertion unit 1040 may insert a keyword into the answer received by the answer receiver 1030. Herein, the keyword may be a word that may be used to calculate semantic similarity to a word set to be generated by the word set generator 1070. The present disclosure is not limited thereto, and a keyword may be inserted by a user or be generated based on a prompt and/or a question input into the LLM and then be inserted. In addition, a keyword insertion process may be omitted.

The first embedding vector generator 1050 may generate embedding vectors of sentences separated by the sentence division unit 1020 and an answer from the keyword insertion unit 1040. Specifically, the first embedding vector generator 1050 may generate embedding vectors of the separate sentences and/or the answer with the inserted keyword by using AI models such as “sentence-transformer”, “transformer”, “LLM embedding model” and/or “OpenAI embedding model”

The sentence selection unit 1060 may calculate similarity between the embedding vectors of the sentences generated by the first embedding vector generator 1050 and the embedding vector of the answer with the inserted keyword and then select a sentence with a highest similarity score. Herein, the sentence selection unit 1060 may calculate similarity by using calculation methods such as mean squared difference similarity, cosine similarity, Pearson similarity and L2 may be used to calculate similarity. In addition, a library like Facebook AI similarity search (faiss) or an engine like elasticsearch may be used to calculate similarity.

The word set generator 1070 may generate a word set by using words present in the sentence selected by the sentence selection unit 1060 and/or the answer received by the answer receiver 1030. Specifically, the word set generator 1070 may divide the selected sentence into word units and remove a stop word. A stop word means a word that frequently appears in a sentence but is not quite useful in analyzing the sentence. A stop word may be defined by a user in advance and be defined by using a library such as the natural language toolkit (nltk).

In addition, the word set generator 1070 may generate a prompt word set with a same number of words as an answer. If an answer has one word, the word set generator 1070 may not generate a word set because the one word is already a unit of word set division. As another example, if an answer has n words, the word set generator 1070 may generate a new word set by combining words present in a prompt in n units. Herein, n may be a natural number.

The second embedding vector generator 1080 may generate an embedding vector of word sets that are generated by the word set generator 1070. Specifically, the second embedding vector generator 1080 may generate an embedding vector by using AI models such as “sentence-transformer”, “transformer”, “LLM embedding model” and/or “OpenAI embedding model” for generated word sets and an answer with an inserted keyword. However, if the first embedding vector generator 1050 has already generated an embedding vector of an answer with an inserted keyword, the second embedding vector generator 1080 may omit the process of generating an answer with an inserted keyword. In this case, the second embedding vector generator 1080 may generate only an embedding vector of a word set that is generated by the word set generator 1070.

The hallucination score calculation unit 1090 may calculate a hallucination score based on embedding vectors that are generated by the second embedding vector generator 1080. Specifically, the hallucination score calculation unit 1090 may calculate similarity between embedding vectors of generated word sets and/or an embedding vector of an answer with an inserted keyword. After calculating similarity, the hallucination score calculation unit 1090 may return a highest similarity score. The hallucination score calculation unit 1090 may calculate similarity by using calculation methods such as mean squared difference similarity, cosine similarity, Pearson similarity and L2 may be used to calculate similarity. In addition, a library like Facebook AI similarity search (faiss) or an engine like elasticsearch may be used to calculate similarity.

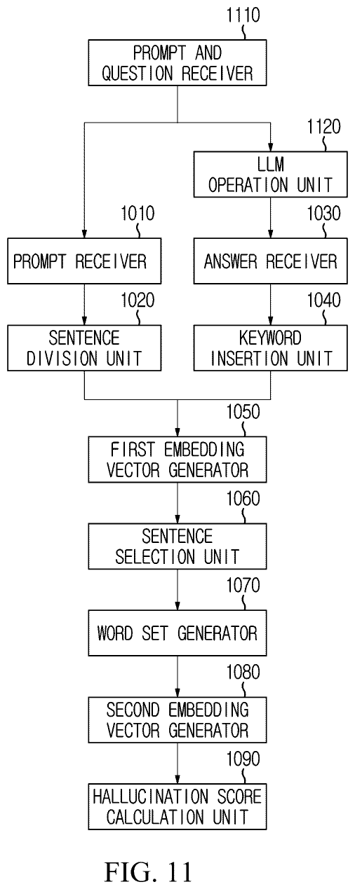

FIG. 11 illustrates a structure of a hallucination scoring apparatus according to another embodiment of the present disclosure. Referring to FIG. 11, the hallucination scoring apparatus may include a prompt and question receiver 1110, an LLM operation unit 1120, the prompt receiver 1010, the sentence division unit 1020, the answer receiver 1030, the keyword insertion unit 1040, the first embedding vector generator 1050, the sentence selection unit 1060, the word set generator 1070, the second embedding vector generator 1080, and the hallucination score calculation unit 1090.

The prompt and question receiver 1110 may receive a prompt and a question that are entered by a user. The prompt received by the prompt and question receiver 1110 may then be input into the prompt receiver 1010. In addition, the prompt and question received by the prompt and question receiver 1110 may be transmitted to the LLM operation unit 1120.

The LLM operation unit 1120 may derive an answer by using the prompt and question received from the prompt and question receiver 1110. That is, the LLM operation unit 720 may derive the answer to the question entered by the user. The answer generated by the LLM operation unit 1120 may be transmitted to the answer receiver 1030. Herein, an LLM model may be BERT, ChatGPT, gpt, Llama and the like, but the present disclosure is not limited thereto.

The same functions described in FIG. 10 may be performed by the prompt receiver 1010, the sentence division unit 1020, the answer receiver 1030, the keyword insertion unit 1040, the first embedding vector generator 1050, the sentence selection unit 1060, the word set generator 1070, the second embedding vector generator 1080, and the hallucination score calculation unit 1090, which are included in the hallucination scoring apparatus of FIG. 11.

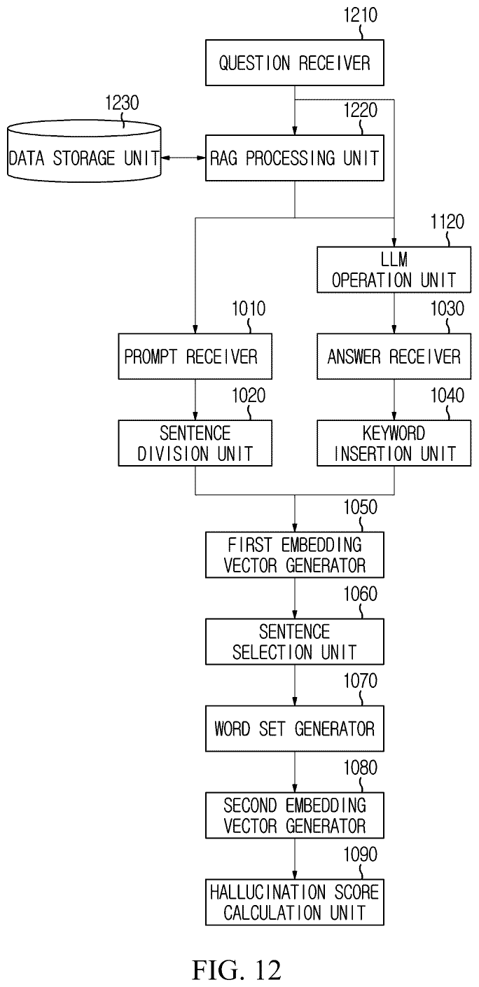

FIG. 12 illustrates a structure of a hallucination scoring apparatus according to another embodiment of the present disclosure. Referring to FIG. 12, the hallucination scoring apparatus may include a question receiver 1210, a RAG processing unit 1220, a data storage unit 1230, the LLM operation unit 1120, the prompt receiver 1010, the sentence division unit 1020, the answer receiver 1030, the keyword insertion unit 1040, the first embedding vector generator 1050, the sentence selection unit 1060, the word set generator 1070, the second embedding vector generator 1080, and the hallucination score calculation unit 1090.

The question receiver 1210 may receive a question that is entered by a user. Herein, the question receiver 1210 may not separately receive a prompt. The question received by the question receiver 1210 may be transmitted to the RAG processing unit 1220. The RAG processing unit 1220 may retrieve a prompt from an external data source and generate a text based on information on the prompt. Accordingly, the RAG processing unit 1220 may retrieve a most appropriate prompt for an entered question from the data storage unit 1230 and receive a retrieval result.

A prompt received by the RAG processing unit 1220 may be transmitted to the prompt receiver 1010. In addition, a prompt received by the RAG processing unit 1220 and/or a question received by the answer receiver 810 may be transmitted to the LLM operation unit 1120. When receiving the prompt and the question, the LLM operation unit 1120 may derive an answer by using the received prompt and question. That is, the LLM operation unit 720 may derive the answer to the question entered by the user. The answer generated by the LLM operation unit 1120 may be transmitted to the answer receiver 1030. Herein, an LLM model may be ChatGPT, gpt, Llama and the like, but the present disclosure is not limited thereto.

The same functions described in FIG. 10 may be performed by the prompt receiver 1010, the sentence division unit 1020, the answer receiver 1030, the keyword insertion unit 1040, the first embedding vector generator 1050, the sentence selection unit 1060, the word set generator 1070, the second embedding vector generator 1080, and the hallucination score calculation unit 1090, which are included in the hallucination scoring apparatus of FIG. 12.

### Accuracy Determination Based on Hallucination Score

A language processing system may check accuracy of an answer by using a calculated hallucination score, and a user may determine, through the calculated hallucination score of the answer, whether or not to trust corresponding information. Alternatively, the language processing system itself may determine accuracy based on a hallucination score. In this case, the language processing system may not open the hallucination score to the user.

Accuracy determination based on a hallucination score may be performed based on a threshold value. For example, the language processing system may determine, for a hallucination score (or similarity score) equal to or smaller than (or smaller than) the threshold value, that a corresponding answer has low reliability, and for a hallucination score (or similarity score) equal to or greater than (or greater than) the threshold value, that a corresponding answer has reliability.

In addition, the language processing system may fine-tune data used for LLM learning by using a calculated hallucination score. By including a hallucination scoring process in a post-processing process of an existing LLM, the present disclosure may implement an “easy and trustworthy AI service”

Exemplary methods of the present disclosure are presented as a series of operations for clarity of explanation, but this is not intended to limit the order in which steps are performed, and the steps may be performed concurrently or in different orders, if necessary. In order to implement the method according to the present disclosure, other steps may be included in addition to the exemplified steps, other steps may be included except for some steps, or additional other steps may be included except for some steps.

Various embodiments of the present disclosure are not intended to list all possible combinations, but are intended to explain representative aspects of the present disclosure, and matters described in various embodiments may be applied independently or in combination of two or more.

In addition, various embodiments of the present disclosure may be implemented by hardware, firmware, software, or a combination thereof. In the case of implementing the present disclosure by hardware, the embodiments of the present disclosure may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), general processors, controllers, microcontrollers, microprocessors, etc.

The scope of the present disclosure includes software or machine-executable instructions (e.g., operating systems, applications, firmware, programs, etc.) that cause operations according to methods of various embodiments to be executed on a device or computer, and a non-transitory computer-readable medium in which such software or instructions and the like are stored and executable on a device or computer.

According to the present disclosure, hallucination scoring can effectively solve the hallucination phenomenon in a large language model (LLM).

According to the present disclosure, a user can evaluation hallucinations through hallucination scoring.

According to the present disclosure, more accurate information can be obtained from an LLM through hallucination scoring.

According to the present disclosure, a hallucination score can be effectively calculated even in a long prompt.

The effects obtainable from the present disclosure are not limited to the above-mentioned effects, and other effects not mentioned herein will be clearly understood by those skilled in the art through the following descriptions.

What is claimed is:

1. A method for determining a hallucination score of an artificial intelligence (AI) model in a language processing system, the method comprising:
receiving a prompt and an answer;
inserting a keyword into the answer;
generating a first word set by using words present in the prompt;
generating a second word set by using words present in the answer with the inserted keyword;
generating embedding vectors of the first word set and the second word set; and
calculating a hallucination score based on the embedding vectors.

2. The method of claim 1, wherein an embedding vector of the second word set is an embedding vector for one or more words combining a keyword and an answer.

3. The method of claim 2, wherein the first word set is generated based on a number of words of the answer.

4. The method of claim 2, wherein the calculating of the hallucination score comprises:
calculating a similarity score between an embedding vector of the first word set and the embedding vector of the second word set; and
calculating the hallucination score based on the similarity score.

5. The method of claim 4, further comprising determining reliability of the answer based on comparison between the hallucination score and a threshold value.

6. The method of claim 5, wherein based on the hallucination score be equal to or greater than the threshold value, the reliability of the answer is determined to be high, and
wherein based on the hallucination score be smaller than the threshold value, the reliability of the answer is determined to be low.

7. The method of claim 4, wherein the similarity score is calculated using one method among mean squared difference similarity, cosine similarity, Pearson similarity, or L2.

8. The method of claim 1, wherein the generating of the first word set further comprises:
based on the prompt including a plurality of sentences, dividing the prompt into sentence units;
generating a first embedding vector of the plurality of the divided sentences;
generating a second embedding vector of the second word set;
calculating a similarity score based on the first embedding vector and the second embedding vector;
selecting a sentence with the similarity score being highest; and
generating word sets by using words present in the selected sentence and the answer with the inserted keyword.

9. The method of claim 1, wherein the receiving of the prompt and the answer comprises:
receiving a question and the prompt from a user;
inputting the question and the prompt into an artificial intelligence (AI) system;
obtaining an answer based on the prompt and the question that are input into the AI system; and
receiving the obtained answer.

10. The method of claim 1, wherein the receiving of the prompt and the answer comprises:
identifying a question input from a user;
receiving a prompt from an external database based on the question;
inputting the question and the prompt into an AI system;
obtaining an answer based on the prompt and the question that are input into the AI system; and
receiving the obtained answer.

11. The method of claim 1, wherein the embedding vector is generated by using an AI model, and
wherein the AI model includes at least one of a sentence-transformer, a transformer, an LLM embedding model, or an OpenAI embedding model.

12. An apparatus for determining a hallucination score of an artificial intelligence model in a language processing system, the apparatus comprising:
a storage unit configured to store information necessary for operation of the apparatus; and
a processor connected to the storage unit,
wherein the processor is configured to:
receive a prompt and an answer,
insert a keyword into the answer,
generate a first word set by using words present in the prompt,
generate a second word set by using words present in the answer with the inserted keyword,
generate embedding vectors of the first word set and the second word set, and
calculate a hallucination score based on the embedding vectors.

13. The apparatus of claim 12, wherein the processor is further configured to:
based on the prompt including a plurality of sentences, divide the prompt into sentence units,
generate a first embedding vector of the plurality of the divided sentences,
generate a second embedding vector of the answer with the inserted keyword,
calculate a similarity score based on the first embedding vector and the second embedding vector,
select a sentence with the similarity score being highest, and
generate word sets by using words present in the selected sentence and the answer with the inserted keyword.

14. The apparatus of claim 12, wherein the processor is further configured to:
receive a question and the prompt from a user,
input the question and the prompt into an artificial intelligence (AI) system,
obtain an answer based on the prompt and the question that are input into the AI system, and
receive the obtained answer.

15. The apparatus of claim 12, wherein the processor is further configured to:
receive a question from a user,
receive a prompt from an external database based on the question,
input the question and the prompt into an AI system,
obtain an answer based on the prompt and the question that are input into the AI system, and
receive the obtained answer.
